(19) United States
(12) Patent Application Publication
(10) Pub. No.: US 2008/0239961 A1
(43) Pub. Date: Oct. 2, 2008

(54) Packet routing based on application source

(75) Inventors: Israel Hilerio, Redmond, WA (US); Eric B. Watson, Redmond, WA (US); Lingan Satkunanathan, Kirkland, WA (US); Bjorn B. Levidow, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/731,220

(22) Filed: Mar. 30, 2007

(51) Int. Cl. H04J 1/16

(52) U.S. Cl. 370/235; 370/389

(57) ABSTRACT

A traffic manager may monitor network performance, detect that the network performance has changed, and may prioritize network traffic based on which application or function is associated with the traffic. Each packet of network traffic may be analyzed to determine a source application or source function and allowed or disallowed along the network based on a set of predetermined priorities. Several sets of priorities may be established for various network performance conditions. In some embodiments, traffic may be routed along different paths using the sets of priorities and the source application or function. The traffic manager is adaptable for web-based services, applications, or other functions provided over a network connection.

### BACKGROUND

Changes in network bandwidth can have adverse effects on a business that relies on a communications network. Often, a business may have several different network traffic streams that utilize the network bandwidth, some streams being more important than others. However, when network bandwidth decreases, business critical network traffic may be competing with non-business critical traffic for a limited amount of bandwidth.

### SUMMARY

A traffic manager may monitor network performance, detect that the network performance has changed, and may prioritize network traffic based on which application or function is associated with the traffic. Each packet of network traffic may be analyzed to determine a source application or source function and allowed or disallowed along the network based on a set of predetermined priorities. Several sets of priorities may be established for various network performance conditions. In some embodiments, traffic may be routed along different paths using the sets of priorities and the source application or function. The traffic manager is adaptable for web-based services, applications, or other functions provided over a network connection.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a system with a network gateway.

FIG. 2 is a diagram of an embodiment showing a method for generating policies and using a policy to route packets.

FIG. 3 is a diagram of an embodiment showing a method for routing an outgoing packet.

### DETAILED DESCRIPTION

Network traffic may comprise traffic that originated from different applications or traffic that is a result of several different functions. When a network experiences a loss in performance, a traffic manager may apply a set of priorities to the network traffic based on the application from which the traffic originated, by the function performed by the traffic, by the user associated with the traffic, or by various combinations of factors. In some cases, the traffic manager may redirect specific traffic through alternative network paths.

A network monitor may continually or periodically monitor the performance of a network connection. When the performance changes below a predetermined threshold, a set of priorities may be applied to the traffic to block certain traffic but allow other traffic. The set of priorities may be embodied in a policy that is applied to specific situation.

During a period of applying a set of priorities, a network manager may determine a source application or a source function for each of the outgoing network packets. In some instances, a packet source may be determined by an incoming port number, analyzing the header information, or by detailed analysis of the contents of a packet.

In some cases, an application may be used to perform several different functions. For example, a backup system may be executed through a web browser. After analyzing the contents of a network packet, the packet may be blocked because it is performing a disallowed function within an allowed application.

Some applications or functions may be prioritized in different manners. For example, a backup function, web browsing, file transfer protocol, or other traffic may be disabled during a period of low bandwidth while business critical applications, virtual private network connections, voice over IP, or other traffic may be allowed to pass through. In some cases, certain traffic may be routed through an alternate path, such as sending voice over IP traffic through a backup network path and sending other traffic over a reduced bandwidth path. Some embodiments may also have different priority settings for certain users.

More and more services, applications, and functions within applications are provided over the Internet, wide area networks, or other network connections. Many applications may be provided as web-based services accessed using a browser. Because of this, network connections can become a critical element of a business network. By determining a function of an outgoing packet, a gateway may allocate a limited bandwidth resource to those high priority applications or functions.

An example of such a service is a web-based application. Such an application is one which uses a web browser as an interface. The operating application on a client device may be a generic web browser, but the web-based application can be any type of application including email, accounting, games, spreadsheets, presentation applications, computer aided design applications, or any other application. Web-based applications or services use a network connection to connect a client device to the web-based server. When the network connection degrades, some web-based applications may have a higher priority than other network traffic.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

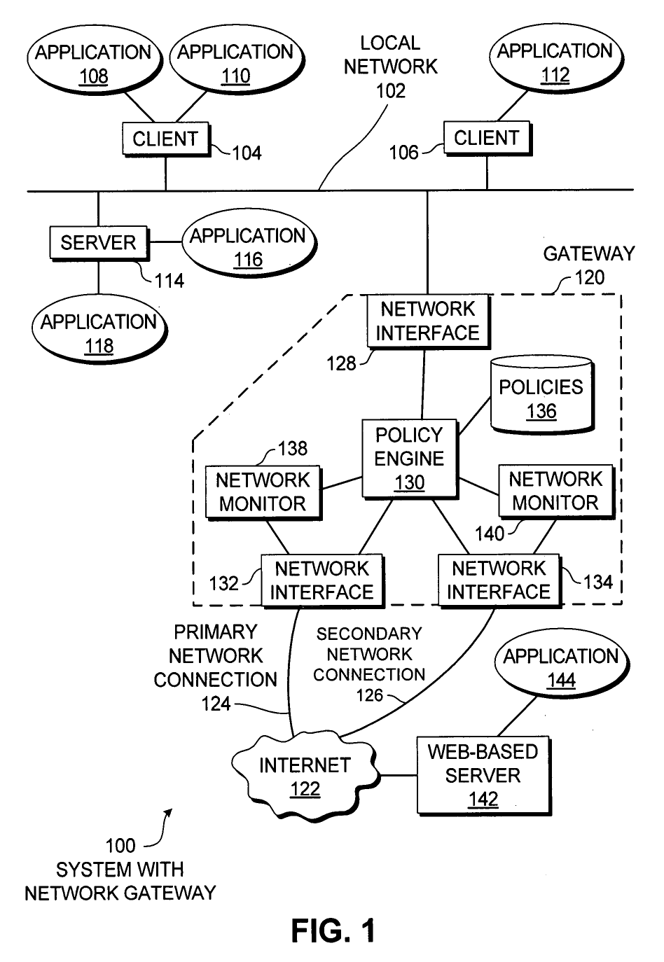

FIG. 1 is a diagram of an embodiment 100 showing a system with a network gateway. The local network 102 may have clients 104 and 106, where client 104 is operating applications 108 and 110 and client 106 is operating application 112. Similarly, server 114 is operating applications 116 and 118. Additionally, web-based server 142 is providing application 144 that may be accessed by clients 104 or 106 as well as server 114.

The gateway 120 provides access to the Internet 122 or other network through a primary network connection 124 and a secondary network connection 126. The gateway 120 may manage outgoing network communications based on the network performance of the network connections 124 and 126. When the network performance changes, such as when the network performance degrades to a certain level, outgoing packets may be handled in different ways, depending on the source application, the function provided by the source application, the user, or other factors.

The gateway 120 has a network interface 128 that connects to the local network 102 and routes outgoing packets to a policy engine 130, which may route the outgoing packet through a network interface 132 connected to the primary network connection 124 or a network interface 134 connected to the secondary network connection 126. The policy engine 130 may apply policies 136 to determine how to route each outgoing packet. A network monitor 138 may monitor the primary network connection 124 through the network interface 132. Similarly, a network monitor 140 may monitor the primary network connection 126 through the network interface 134.

The gateway 120 may sense changes in network performance and respond to the performance change by regulating which outgoing packets are transferred outbound on the network connections 124 or 126. In a business setting, some communications may have a higher priority than others. Those priorities may be determined by several factors, including specific applications and functions within those applications from which the outgoing packets originate.

For example, business applications that have a high priority may include virtual private network connections to other business offices, email or chat applications that are used for live customer support, accounting applications, or other applications. Similarly, applications that may have a low priority may include general web browsing, file transfer protocol transfers, and data backup applications.

In some applications, a specific function performed by the application may have different priorities assigned thereto. For example, a web browser application may perform a low priority backup or web surfing function, but also may provide an interface into a high priority, mission critical accounting function that is delivered through the web-based server 142 over the Internet 122. When analyzing an outgoing packet, the policy engine 130 may be able to determine a source application, which in this case is a web browser. The policy engine 130 may also be able to determine a specific function performed by the source application. If the function is a high priority function, the outgoing packet may be allowed and transferred over a network connection and if the function is a low priority function, the outgoing packet may be dropped or returned.

Many applications may have functions with different priorities. For example, an accounting system may provide high priority real time accounting information to remote sites but may also perform low priority backup functions. A backup application may provide high priority data recovery from a network based backup repository, and may also provide low priority, bandwidth consuming backup of a client system.

The policy engine 130 may detect a source application and a source function by analyzing an outgoing packet in several manners. In many cases, an outgoing packet may have a header or other metadata from which a source application and sometimes a specific function within the source application may be determined directly from the metadata. In other cases, the data payload of a packet may be analyzed to determine a source application or function.

In some cases, a function may be able to be identified from a packet but not a source application, and in other cases the source application may be determined but not the function of the application.

The policy engine 130 may be able to detect a source application or other information from the port from which an outgoing packet is received. Some applications or functions may have a specific port through which communications for the application or function are passed.

The gateway 120 may analyze outgoing packets to determine the source application for the packet and route the outgoing packet accordingly. High priority outgoing packets may be transmitted through a limited bandwidth primary network connection 124 or through a backup or secondary network connection 126. Low priority packets may be dropped, returned, or routed through a low priority or low bandwidth channel.

Gateway 120 may regulate overall network traffic by regulating outgoing communication from a local network 102 to the Internet 122 or other network. In many situations, network traffic uses a two-way communication, where one application sends a communication and receives a reply from another application. When outgoing packets are regulated, the net effect may be to regulate all communications.

The network monitors 138 and 140 may measure network performance so that an appropriate policy 136 may be applied to outgoing packets. In conditions where network performance is excellent, a policy 136 may permit all outgoing packets to be transmitted on the primary network connection 124. In conditions where network performance is degraded somewhat, a small number of functions or applications may be restricted from transmitting. If the network performance along the primary network connection 124 degrades further, some high priority traffic may be routed along the secondary network connection 126, which may be a high cost network connection, for example. The policies 136 may be applied when network performance is in a degraded state but still functioning. Additional policies 136 may be applied when one of the network connections 124 and 126 may be completely offline.

The network monitors 138 and 140 are illustrated as part of the gateway 120. The network monitors may be dedicated hardware devices that measure physical characteristics of the network connections, or may be software or firmware components that periodically measure network performance. In other embodiments, the network monitors 138 or 140 may be remote devices, standalone devices, or any other configuration by which a network performance characteristic may be detected and monitored.

The network 102 may be any type of local network that uses a gateway 120 to connect to another network, which may be another local network, a wide area network, or the Internet 122. Various devices may connect to the network 102 and use the gateway 120 to communicate outside the local network 102. Such devices may include server devices 114 that provide services, data, or applications to client devices 104 and 106. The devices may be personal computers and server computers, but may also include various network appliances, personal digital assistants, wirelessly connected laptop computers, game controllers, industrial controllers, network switching gear, telephony devices, printers, scanners, or any other device that may communicate over a network.

The various devices may perform different functions using various applications. In some instances, a device may have a general purpose processor adapted to execute a software application. In other instances, a device may have firmware, hardware, field programmable gate arrays, read only memory, or other mechanisms to enable the device to perform certain functions. The devices may include single purpose devices such as telephony devices that perform a dedicated function as well as a multi-purpose device such as a personal digital assistant and a general purpose device such as a personal computer.

The network 102 may be a hardwired network that may include Ethernet, token ring, DOCSIS, fiber optic, or other mechanism, as well as a wireless network that may use IEEE 802.11, mesh networks, or other wireless technologies.

The gateway 120 may connect to and manage traffic over one or more network connections. In embodiments with one network connection, low priority traffic may be cached, dropped, or returned. In embodiments with two or more network connections, specific traffic may be routed on specific network connections in a specific manner.

For example, a business may be configured with a primary network connection 124 and a secondary network connection 126. The primary network connection 124 may be normally used for day to day network traffic and may be capable of handling all the traffic for the business. The secondary network connection 126 may be a backup network connection that may be expensive to use, such as a network connection using satellite technologies. When the primary network connection 124 becomes degraded, some high priority applications may have packets routed through the secondary satellite network connection 126 while low priority packets may be routed through the degraded primary network connection 124.

In some instances, measured network parameters may be used to route outgoing packets. For example, a packet for a voice over internet protocol (VoIP) or other telephony application may require low latency and low out-of-order packet transmission errors. A policy may include routing packets for a telephony application through a network interface with better performance parameters suited to the telephony application.

The measured network parameters may be any network parameter. For example, parameters may include latency, jitter, packet loss, data throughput, dropped packets, out of order delivery, and bit error rate. Any other measurable or calculable network parameter may be used.

In some embodiments, a specific user may be identified with an outgoing packet, and a policy may enable prioritizing the outgoing packet based on the user. The user may be determined by analyzing the outgoing packet including header information, metadata, incoming port, or the data payload of a packet.

A policy may be created that gives certain users higher priority than other users, while other policies may be defined that use a combination of user parameters and application parameters to determine a packet routing. For example, a research scientist may be assigned high priority for general web browsing while an inventory clerk in a warehouse may be given low priority for web browsing. In another example, a Chief Executive Officer may be assigned high priority for any type of network traffic. In yet another example, a senior system administrator may be granted a high priority for a backup operation while a normal user may be assigned a low priority for the same operation.

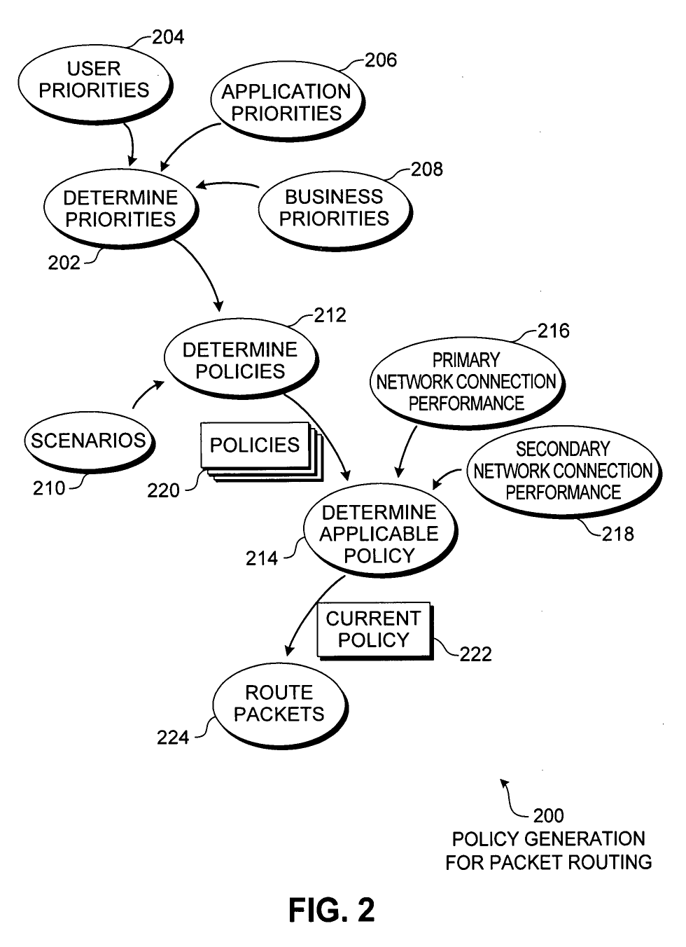

FIG. 2 illustrates an embodiment 200 showing a method for policy generation for packet routing. The embodiment 200 is one mechanism by which a set of policies may be created that are later used for packet routing.

Priorities are determined in block 202 by aggregating user priorities 204, application priorities 206, and business priorities 208. Priorities may be assessed in this manner to aid in developing various priorities that will be applied to packet routing. In other embodiments, priorities may be defined in a manner adapted to a particular implementation or business situation.

User priorities 204 may assign a priority for different users in any useful way. For example, user priorities 204 may include a separate priority setting for each individual user on a network, or user priorities may be assigned based on type of user. In such an example, customer service employees may be assigned one priority as a group, while system administrators may be assigned a different priority.

User priorities may be inferred from a particular device on the network. For example, a person's personal computer may have an address on a network and user priorities for that user may be assigned to the address for the personal computer. When a priority engine analyzes an outgoing packet, a priority for a particular user may be applied based on the device from which the packet originated. In other embodiments, an outgoing packet may be analyzed to find a specific user associated with the outgoing packet, regardless of the originating device.

Application priorities 206 may include priorities assigned to specific software applications, types of applications, functions within applications, or any other classification for the actions that may have created an outgoing packet. For example, a specific software application may be identified and have a priority set for the application. In another example, certain functions, such as a backup function, may have a given priority, regardless of which application is performing the function. In the example, a dedicated backup application may backup data files and may be assigned the same priority as a backup function that operates within an accounting program. Similarly, a backup system that operates through a web browser interface may also be assigned the same priority.

In some embodiments, entire groups of applications may be assigned a priority. For example, a suite of different applications may be assigned a particular priority. In another example, the set of email applications may have a defined priority, even if one email application is from a first vendor and another email application is from a second vendor.

The prioritization of applications and functions may be defined by the ability of a policy engine to determine the source application or function. In some situations, a policy engine may be able to determine that a packet is part of a telephony transmission but may not be able to distinguish which application created the packet. Hence, an application priority may be assigned to telephony transmissions rather than specific applications that create such packets.

Business priorities 208 may be a set of rules or other expressions that capture a business process. For example, a business process may have a high priority for backup operations during nighttime, when the business is closed, and a low priority for backup operations during regular business hours. In another example, a customer service department may be giving the highest priority for traffic that directly interacts with customers, such as real time chat, email, and order taking.

Using various scenarios 210, policies can be determined in block 212. An example of a scenario may be a condition where a primary network connection is degraded to a specific level and a secondary network connection is operating at full capacity. Another scenario may be where the primary network connection is degraded to a different level and a secondary network connection is not available. A third scenario may be where the primary network connection is significantly degraded and a secondary network connection is partially degraded as well. Several different situations or scenarios 210 may be created and, using the priorities determined in block 202, separate policies 220 may be created. In some instances, separate policies may be created for each scenario.

The applicable policy to be implemented is determined in block 214, using primary network connection performance 216 and secondary network connection performance 218. Other factors may also be used, including time of day, day of the week, current network traffic capacity, or any other factor. One of a several policies 220 may be selected and made into the current policy 222 that may be implemented by a policy engine to route packets 224.

In some embodiments, the performance of network connections as in blocks 216 and 218 may be measured continually and used to change policies on a real time basis. In other embodiments, a change in policies may be performed after analyzing network performance for a period of time. For example, a policy change may be implemented after a network parameter has fallen below or above a predetermined level for five seconds, five minutes, or an hour. In yet other embodiments, a change in network performance may trigger a user interface and enable a user, such as a network administrator, to manually approve a change in packet routing policy.

In some instances, a policy change may be implemented proactively in anticipation of a change in network traffic or network connection performance. Such a policy change may be implemented automatically and dictated by a business priority 208, or may be manually selected and implemented by a network administrator.

Different embodiments may have different mechanisms for determining policies, changing policies, and implementing policies. In some implementations, wide changes in network performance may cause large, discrete changes in network polices. Other implementations may have finer changes that track subtle changes in network performance.

Some policy engines may analyze each outgoing packet in order to route the packet appropriately. Other policy engines may analyze one or several packets when a communication session is established to determine the appropriate routing, then route subsequent packets in the same session the same way without analyzing subsequent packets.

A policy may be a specific set of rules that defines specifically which packets will be transmitted based on the application, function, user, or other parameter that can be extracted by inspecting or analyzing the packet. The policy may be applied when a certain condition is met and kept in place until another policy is applied when conditions change.

In other cases, the policy may have a variable function that may change which packets are transmitted based on a network performance variable. For example, an embodiment may have a priority assignment for a specific combination of user, application, function, and business rules that may be applied to a specific outgoing packet. When each outgoing packet has a calculable priority assignment, a policy may be applied that uses a function with a network performance parameter to determine how the packet is to be handled. Each packet may be transmitted or not based on a function that uses a numerical input based on network performance.

In a simple example of such a case, an aggregated network performance variable may be calculated from one or more measured variables to yield a current network performance variable of 75%. A policy may use the calculated 75% figure to allow packets in the top 75% of the priority rating to be transmitted. In such an example, the policy compares a network performance variable with a numerical priority for an outgoing packet.

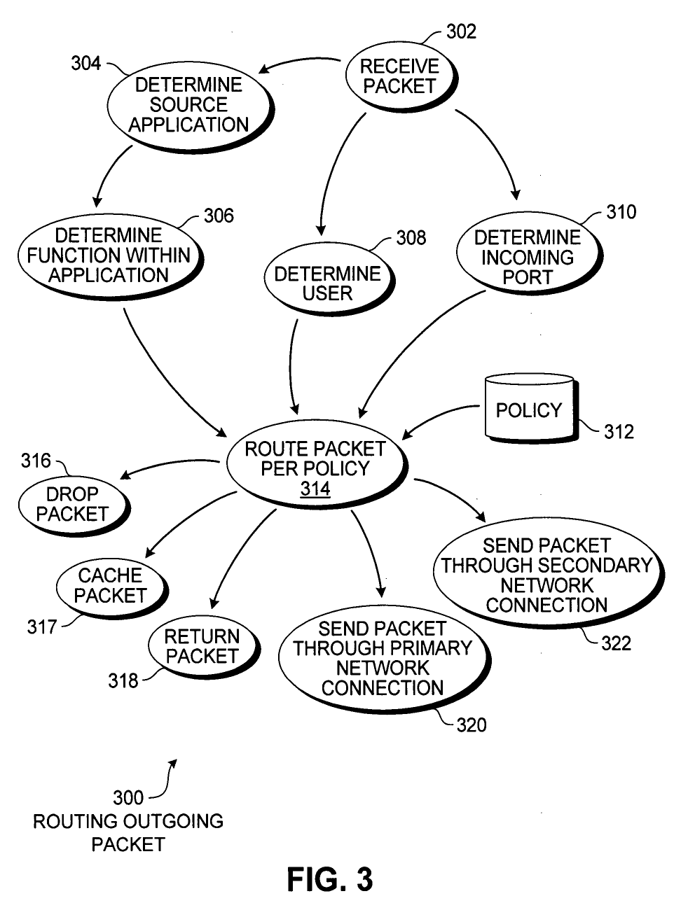

FIG. 3 is a diagram illustrating an embodiment 300 of a method to route an outgoing packet. In block 302, the outgoing packet is received. A source application is determined in block 304 and a function within the source application is determined in block 306. A user is determined in block 308 as well as an incoming port in block 310.

Using a policy 312, the packet is routed in block 314. Each packet may be routed in several different ways. A packet may be dropped in block 316. A packet may be cached in block 317 and transmitted at a later time when bandwidth or network performance allows. A packet may be returned or a sending application notified in block 318 that the packet will not be transmitted. A packet may be transmitted through a primary network connection in block 320 or transmitted through a secondary network connection in block 322.

When a packet is returned to a sending application as in block 318, various handshaking processes may be used. In some instances, a packet may be returned with a generic message that indicates that a remote server is unavailable. In such an instance, the sending application may respond as if the network is completely disconnected. In other instances, a packet may be returned with a notification that the packet is being returned by the packet routing policy engine for network throughput reasons. Such an instance may be useful when a sending application may be able to handshake with the policy engine and provide a user with more details about the network connection.

Embodiment 300 is a method by which an outgoing packet may be analyzed and routed based on a policy 312. The analysis of a packet may include determining a source application, function, user, and incoming port. Some embodiments may perform one or more of these analyses or have additional analyses that extract other characteristics of the packet. Based on the analysis of the packet, a policy 312 may indicate how the packet may be routed. Lower priority packets may be dropped or returned. Medium priority packets may be cached and transmitted when possible at a later time, while high priority packets may be routed through various network connections.

The analysis of a packet may be any mechanism by which information about the packet may be obtained. In some instances, sufficient information may be obtained through the incoming port number or header information to determine how to route the packet. In other instances, the data payload of the packet may be analyzed to determine a source application or a function that created the packet. An embodiment may have one or more different analysis mechanisms which may be applied to different packet types.

The use of an incoming port in block 310 may be an indicator that a packet originated with a specific application or is part of a specific function. Many different port numbers have been assigned to specific applications, protocols, or functions. In some cases, two or more functions, users, or applications may use a particular port.

Medium priority packets may be cached in block 317 and transmitted as the network traffic allows at a later time. By caching medium priority packets, high priority packets may be transmitted without delay over a limited bandwidth or a network with lower performance. When the bandwidth becomes available on the network, any cached packets may be transmitted.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
detecting a change in a first network performance parameter on a first network connection;
determining a set of priorities for a plurality of applications;
analyzing an outgoing packet to determine a source application for said packet;
determining a packet priority for said outgoing packet based on said set of priorities and said source application; and
routing said outgoing packet based on said packet priority.

2. The method of claim 1, said routing comprising:
sending said outgoing packet when said packet priority is high; and
dropping said outgoing packet when said packet priority is low.

3. The method of claim 1, said routing comprising:
sending said outgoing packet on a second network connection when said packet priority is high.

4. The method of claim 1, said routing comprising:
sending said outgoing packet on a second network connection when said packet priority is low.

5. The method of claim 1, said set of priorities comprising application functions, said method further comprising:
analyzing said outgoing packet to determine a first application function associated with said outgoing packet; and
routing said outgoing packet.

6. The method of claim 1, said set of priorities comprising user priorities, said method further comprising:
analyzing said output packet to determine a first user associated with said outgoing packet; and
routing said outgoing packet.

7. The method of claim 1, said analyzing further comprising analyzing data contents of said packet.

8. A computer readable medium comprising computer executable instructions adapted to perform the method of claim 1.

9. A system comprising:
a first monitor for a first network connection adapted to determine a performance parameter for said first network connection;
a priority engine adapted to:
analyze an outgoing packet to be sent over said first network connection to determine a first source application for said outgoing packet;
apply a transmission policy for said outgoing packet; and
transmit said outgoing packet over said first network connection based on said transmission policy.

10. The system of claim 9, said performance parameter comprising at least one of a group composed of: latency, jitter, packet loss, data throughput, dripped packets, out of order delivery, and bit error rate.

11. The system of claim 9, said priority adapted further adapted to route said outgoing packet through a second network connection based on said transmission policy.

12. The system of claim 9, said transmission policy comprising priorities based at least one of a group composed of: a user for said outgoing packet, a function associated with said outgoing packet, a port for said outgoing packet, and data contained within said outgoing packet.

13. The system of claim 9 further comprising a second monitor for a second network connection.

14. A method comprising:
monitoring a first performance parameter for a first network connection;
detecting a change in said first performance parameter;
determining a first policy and a second policy for a plurality of applications, said first policy and said second policy comprising a priority for said plurality of applications, said plurality of applications comprising at least one application delivered over said first network connection;
changing a current policy from said first policy to said second policy based on said change in said first performance parameter;
analyzing an outgoing packet to determine an application source; and
routing said packet based on said current policy and said application source.

15. The method of claim 14, said first policy being adapted to allow all packets to be transmitted.

16. The method of claim 14, said plurality of applications comprising at least one of a group composed of: email applications, backup applications, web browsing applications, file transfer protocol applications, virtual private network connection applications, telephony applications, and remote access applications.

17. The method of claim 14, said routing comprising dropping said outgoing packet when said outgoing packet is from a low priority application.

18. The method of claim 14, said first policy and said second policy further comprising a priority for a plurality of functions associated with said plurality of applications.

19. The method of claim 14, said analyzing and outgoing packet being performed by analyzing the data contents of said outgoing packet.

20. The method of claim 14, said at least one application comprising a web-based delivery mechanism.
